(19) United States
(12) Patent Application Publication
(10) Pub. No.: US 2013/0073769 A1
(43) Pub. Date: Mar. 21, 2013

(54) INTEGRATED EXPANSION DEVICE

(71) Applicants: KUO-CHAN PENG, PINGZHEN CITY (TW); CHING-FENG HSIEH, TAIPEI CITY (TW)

(72) Inventors: KUO-CHAN PENG, PINGZHEN CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/280,695

(22) Filed: Oct. 25, 2011

(30) Foreign Application Priority Data
Sep. 16, 2011 (TW) 100133340

(51) Int. Cl. G06F 13/00

(52) U.S. Cl. 710/303

(57) ABSTRACT

An integrated expansion device includes a base, a clamping unit, an input device, a second transmission unit, a display device, and a connection unit. A handheld electronic device can be held by the clamping unit, fixed to a receiving region on the base, and electrically connected to the second transmission unit. The handheld electronic device functions as a computation processing center and a touch panel and is connected to the display device and the input device which are disposed on the base, thereby having a large display screen and an input interface. The display device can be rotated, opened, and shut relative to the base via the connection unit to thereby implement a hardware system equivalent to a notebook computer and enhance applicability and ease of use.

### CROSS-REFERENCE TO RELATED APPLICATION

This non-provisional application claims priority under 35 U.S.C. §119(a) on Patent Application No(s). 100133340 filed in Taiwan, R.O.C. on Sep. 16, 2011, the entire contents of which are hereby incorporated by reference.

### FIELD OF TECHNOLOGY

This invention relates to an integrated expansion device and particularly to an integrated expansion device that may be connected to a handheld electronic device.

### BACKGROUND

Along with progressive technology and fast growing electronics industry, Smartphone, Tablet PC, and Notebook PC as consumer electronic products are popular in modern daily life.

The Notebook PC and the Smartphone are different from each other mainly in size, specification, and operation processing performance; the Notebook PC field is distinguished from the Smartphone field by the demands of mobility and performance. In recent years, along with progressive growing technology, the operation processing performance of Smartphone is close to that of computer and the Smartphone also has relatively small and lightweight characteristics of high mobility. On the other hand, Tablet PC is a consumer electronic product that is popular in recent years, and it is an intermediate between Smartphone and Notebook PC in the aspects of performance, portability, and convenience. Compared with Notebook PC, Tablet PC is provided without a physical keyboard and a physical touch panel and is thin and lightweight for high portability. Compared with Smartphone, Tablet PC is provided with a large display, being easy to work, play for amusement, and surf on Internet.

However, Tablet may be replaced with Smartphone that is continuously weeded through the old to bring forth the new for high operation processing performance. In users' viewpoint, Smartphone and Tablet PC are consumer electronic products that the similar to each other by degree. Further, for the need of communication function and mobility, Smartphone is doubtlessly required more than Tablet PC.

However, Smartphone is subject to the request of communication function and mobility, so the size of Smartphone is confined. Thus, the size of display of Smartphone sold in the market is generally less than 5 inches and thereby Smartphone cannot compete with Tablet PC and Notebook PC, each of which is provided with a large display and an input interface, such as a keyboard, for users to easily operate.

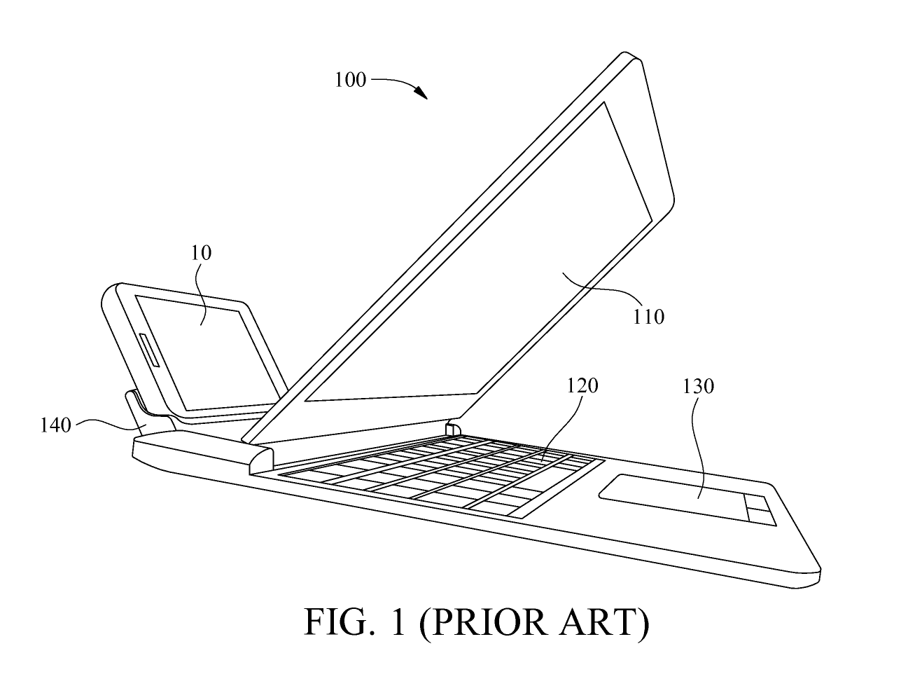

Thus, some platform products designed for expansion feature are provided; it is used to make Smartphone integrate and work with another peripheral for better applicability and convenience. As shown in FIG. 1, an expansion platform 100 is provided with a display device 110, a keyboard 120, a touch panel 130, and an adaptor 140 that may be connected to a Smartphone for loading the Smartphone. The Smartphone 10 is thereby made to serve as a computation processing center for implementing each operation. Thus, when working with the expansion platform 100, the Smartphone 10 may have the large display and both the keyboard 120 and the touch panel 130 as an input interface that helps a user operate, and functions as a Notebook PC for easy operation, thereby depending on the user's option for the demand of mobility and application.

However, the expansion platform 100 is limited to the mobile-phone adaptor 140 of which a transmission connector must match with the size of Smartphone 10 and the position and interface type of transmission port of Smartphone. Thus, the expansion platform 100 may meet a specified model of Smartphone 10 but cannot has a universal use for each model of Smartphone or another handheld electronic device.

Besides, the Smartphone 10 is carried in the phone adaptor 140 behind the expansion platform 100, so the Smartphone cannot be operated or used when the touch display 100 is used. The Smartphone 10 serves only as the computation processing center and thus the touch function of Smartphone 10 is made to be idle, reducing the applicability.

Thus, the conventional advantageous expansion platform that is provided for both Smartphone, as the handheld electronic device, and Notebook PC is limited to the specific corresponding model of handheld electronic device, which is a defect, and thus cannot has the universal use for each model of handheld electronic device. Further, the handheld electronic device is loaded at the rear of expansion platform and thus the touch function of handheld electronic device cannot be used at the same time, causing the limit of applicability.

Consequently, because of the technical defects of described above, the applicant keeps on carving unflaggingly through wholehearted experience and research to develop the present invention, which can effectively improve the defects described above.

### SUMMARY

The object of the present invention is to provide an integrated expansion device that is used to load a handheld electronic device for serving as a computation processing center to enhance applicability and ease of use.

In order to achieve the object mentioned above, the integrated expansion device according to this invention is provided to load a handheld electronic device. The handheld electronic device is provided with a first transmission unit that is used to at least transmit a video/audio signal. The integrated expansion device comprises a base that is provided with a receiving region for receiving the handheld electronic device, a clamping unit that is provided in the receiving region and has at least one adjustment portion that is used to adjust the clamping unit for clamping the handheld electronic device, an input device that is provided on the base and is adjacent to the receiving region for generating at least one first control signal according to a user's input operation, a second transmission unit that is electrically connected to the first transmission unit and the input device for at least receiving the video/audio signal from the handheld electronic device and transmitting the first control signal generated by the input device, a display device that is electrically connected to the second transmission unit for receiving and displaying the video/audio signal, and a connection unit that is provided at a side of the display device and connected to the base for rotating, opening, and shutting the display device relative to the base.

In the integrated expansion device, the display device is a touch display on which a user touches to generate a second control signal. The second control signal is transmitted to the handheld electronic device from the second transmission unit and the first transmission unit.

In the integrated expansion device, the connection unit comprises a hinge for hinging the display device onto the base.

In the integrated expansion device, the display device and the connection unit are respectively provided with a guidance groove and a gliding part that are opposite to each other for making the display device glide on and connect to the base.

In the integrated expansion device, the clamping unit comprising a plurality of clamping portions. The clamping portions are connected to the adjustment portion to adjust the clamping portions for keeping them close to and clamping the handheld electronic device.

In the integrated expansion device, the receiving region is further formed with a receiving slot. The clamping unit is provided in the receiving slot.

In the integrated expansion device, the base further comprises a data read/write device, being electrically connected to the second transmission unit.

In the integrated expansion device, a wired transmission or a wireless transmission is provided between the first transmission unit and the second transmission unit. The wired transmission may comprise, for example, a HDMI, VGA (Video Graphics Array), DVI (Digital Visual Interface), DisplayPort, IEEE 1394, or USB transmission interface; the wireless transmission may comprise, for example, a Bluetooth, Wi-Fi, or NFC (Near Field Communication) transmission interface.

In the integrated expansion device, the input device is a physical keyboard or a virtual keyboard.

In the integrated expansion device, the handheld electronic device is provided with a touch screen.

In the integrated expansion device, the handheld electronic device is a Smartphone.

Thus, with the integrated expansion device described in the embodiment, the handheld electronic device may be loaded therein to serve as the computation processing center. Further, the handheld electronic device may be used to serve as the touch panel. Next, the display device and input device in the integrated expansion device may have the large display screen and the input interface, thereby implementing a hardware system equivalent to a notebook computer and enhancing applicability and ease of use.

### BRIEF DESCRIPTION

FIG. 1 is a schematic view illustrating a conventional expansion platform;

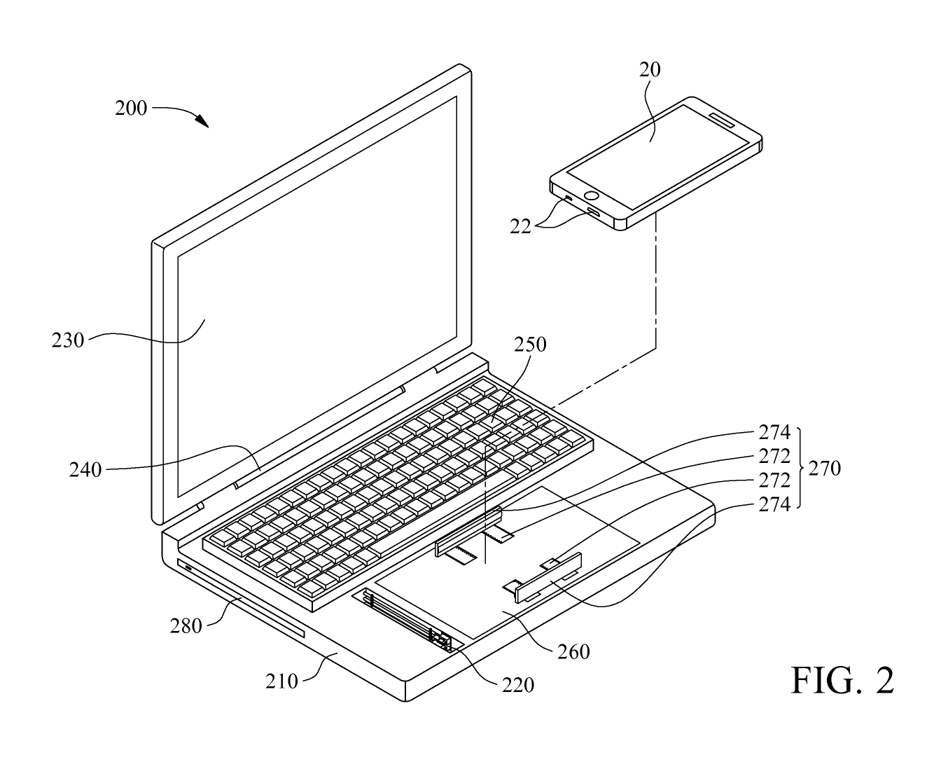

FIG. 2 is a schematic view illustrating an integrated expansion device in a first embodiment of this invention;

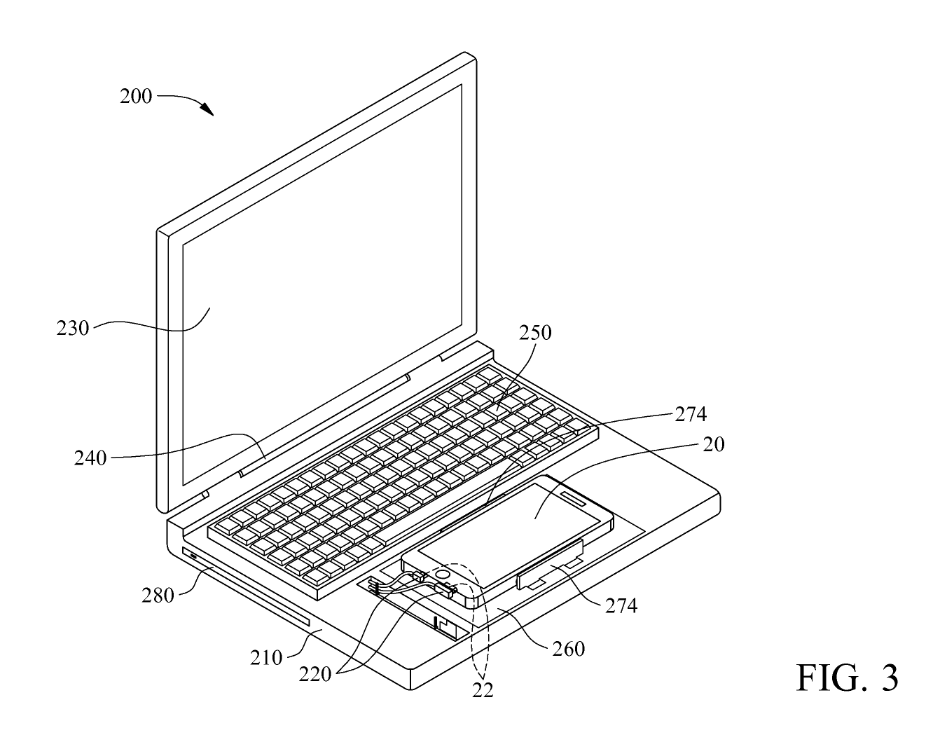

FIG. 3 is a schematic view illustrating the integrated expansion device loading a handheld electronic device in the first embodiment of this invention;

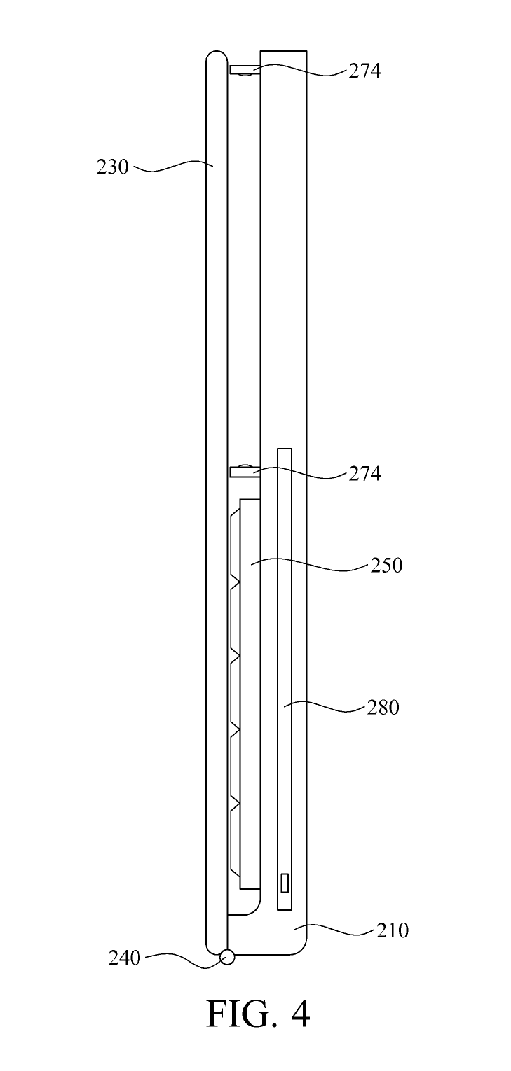

FIG. 4 is a schematic view illustrating the integrated expansion device, in a first embodiment of this invention, where the display device is rotated, opened, and shut relative to the base;

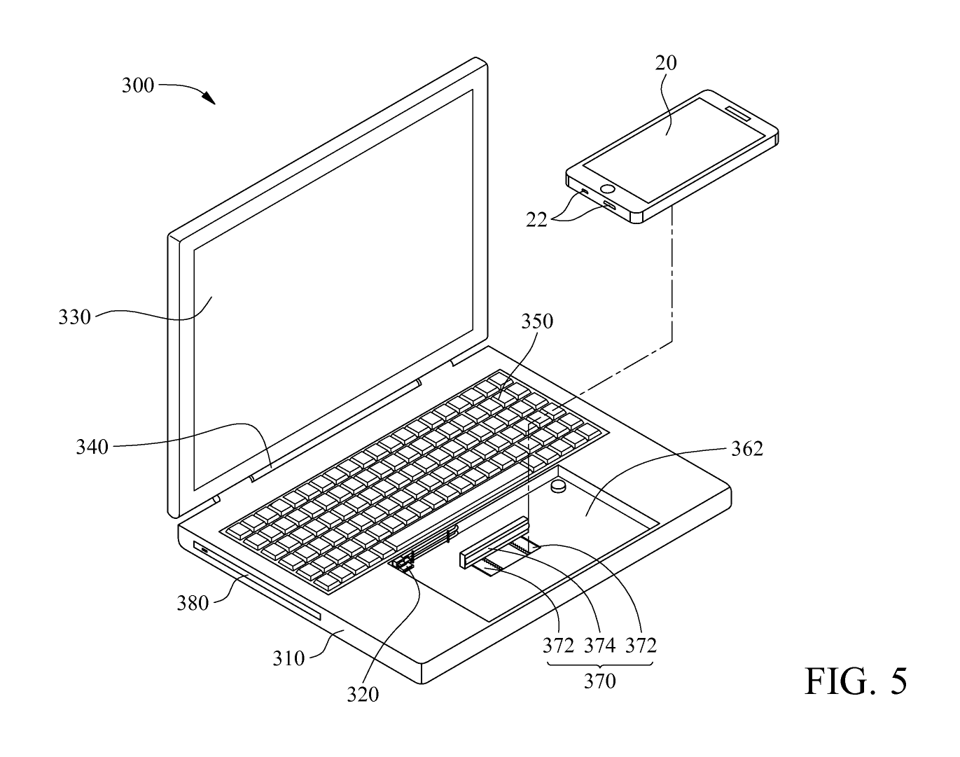

FIG. 5 is a schematic view illustrating the integrated expansion device in a second embodiment of this invention;

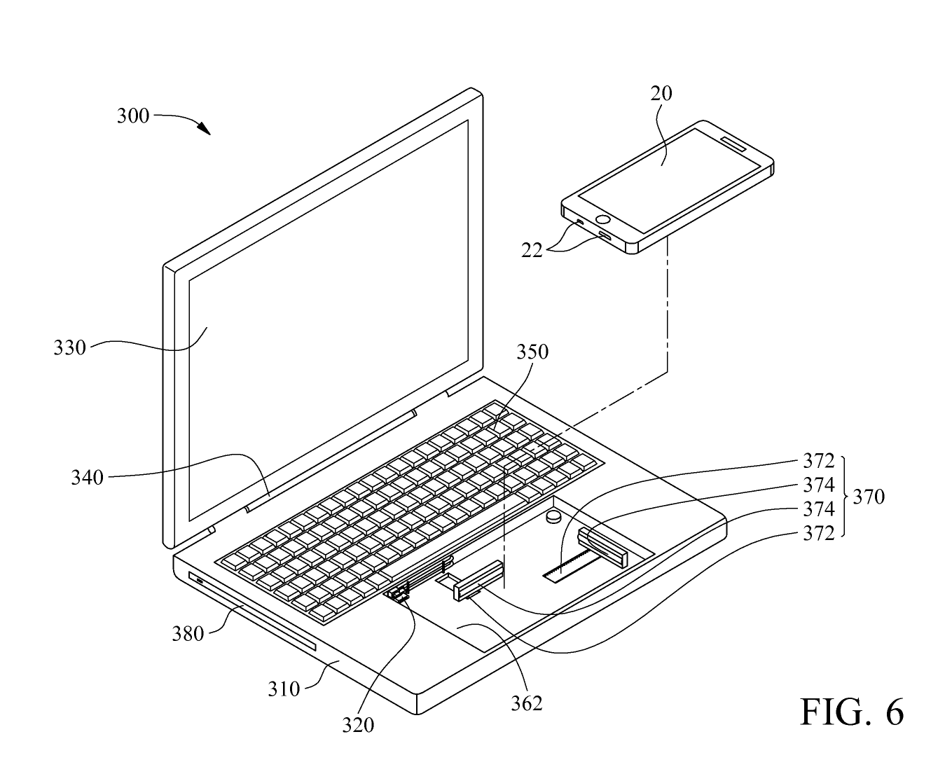

FIG. 6 is a schematic view illustrating the integrated expansion device that is provided with a receiving slot formed with two clamping portions in the second embodiment of this invention;

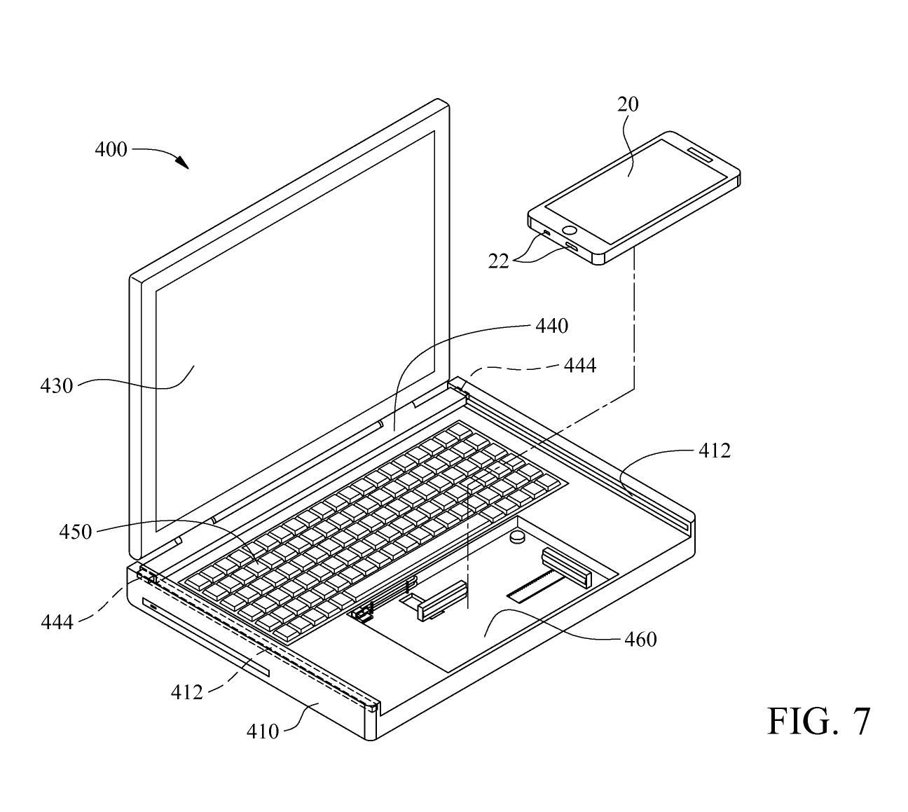

FIG. 7 is a schematic view illustrating the integrated expansion device in a third embodiment of this invention;

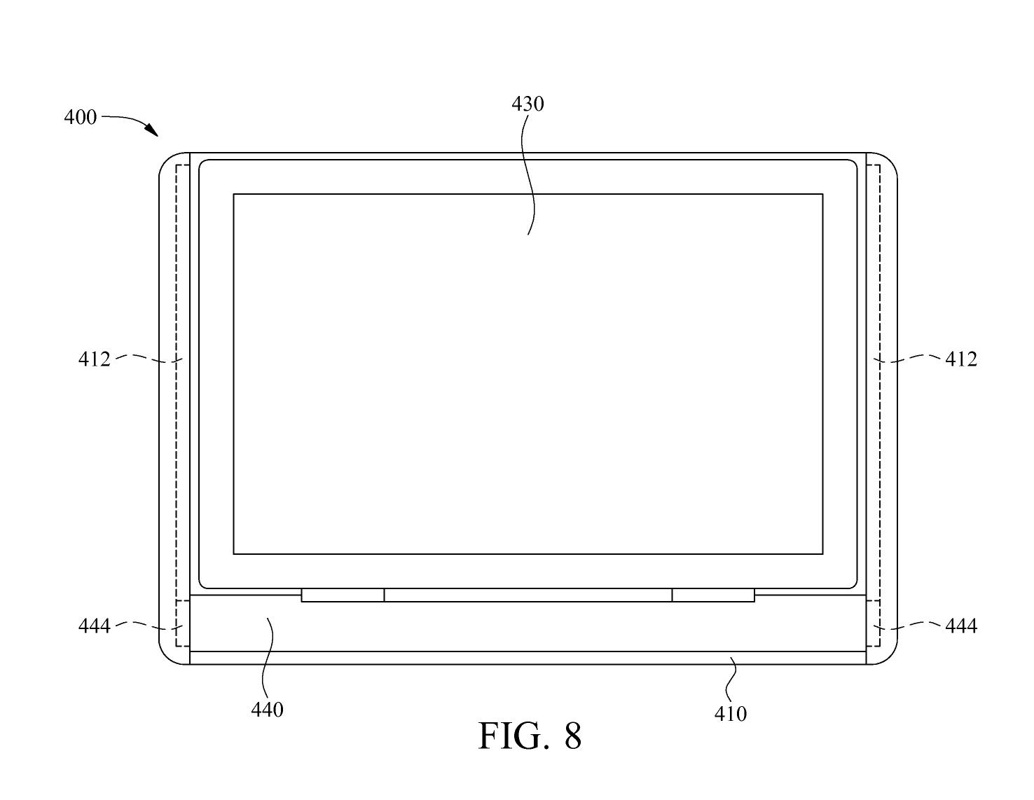

FIG. 8 is a schematic view illustrating the integrated expansion device, in the third embodiment of this invention, where the display device glides from the base for closing;

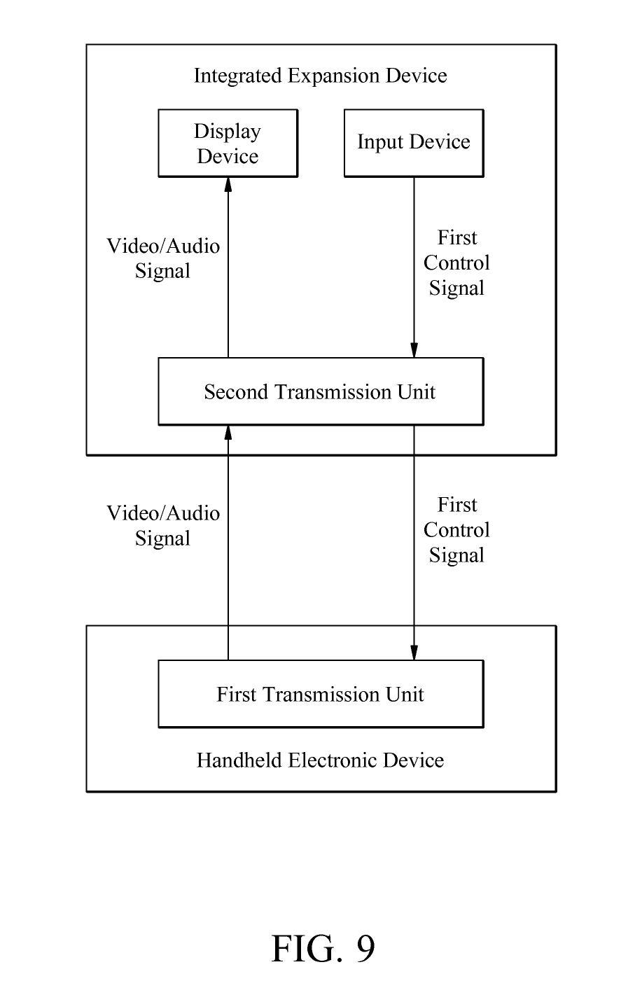

FIG. 9 is a block diagram of a signal transmission between the display device and the handheld electronic device in the integrated expansion device in embodiments 1 through 3; and

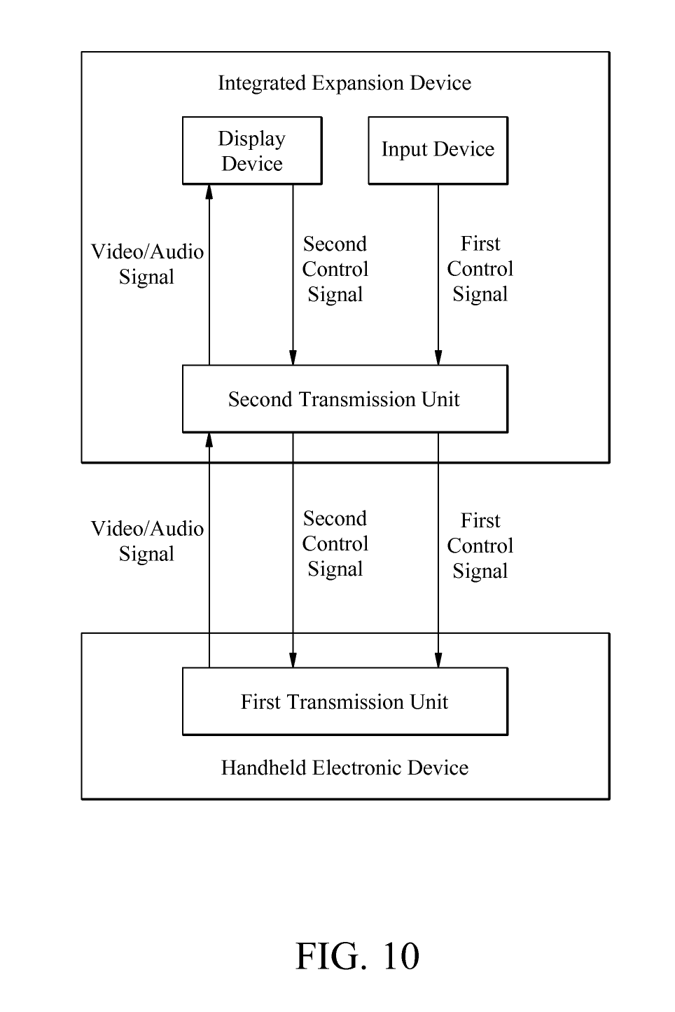

FIG. 10 is a block diagram of a signal transmission between the display device provided with a touch display and the handheld electronic device in the integrated expansion device in embodiments 1 through 3.

### DETAILED DESCRIPTION

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

Refer to FIGS. 2 through 4 as schematic views illustrating a display device in a first embodiment of this invention. An integrated expansion device 200 according to this invention is used to load a handheld electronic device 20. The handheld electronic device 20 is provided with a first transmission unit 22 that is used to at least transmit a video/audio signal. In the embodiment, the handheld electronic device 20 is, for example, a Smartphone but is not limited to such a manner, which may be an electronic device provided with a touch screen, such as a PDA. As long as comprising a transmission interface and an operation processor for a video/audio signal and a control signal, it may be applied to the integrated expansion device according to this invention.

The integrated expansion device 200 according to this invention comprises a base 210, a clamping unit 270, an input device 250, a second transmission unit 220, a display device 230, and a connection unit 240. The base 210 is provided with a receiving region 260 for receiving the handheld electronic device 20. The clamping unit 270 is provided in the receiving region 260. The clamping unit 270 is provided with an adjustment portion 272 to adjust the clamping unit 270 for the size of handheld electronic device 20 so that the clamping unit 270 may tightly clamp the handheld electronic device 20. The input device 250 is provided on the base 210 and is adjacent to the receiving region 260 to generate a first control signal according to a user's input operation. The input device 250 is preferably arranged in a position where a surface on the base 210 is close to the display device 230 that is open. As the allocation of a keyboard and a touch panel on a Notebook PC, the receiving region 260 is preferably arranged in a position where a surface on the base 210 is far from the display device 230 that is open. The handheld electronic device 20 is electrically connected to the first transmission unit 22 to receive the video/audio signal outputted by the handheld electronic device 20 and to transmit the first control signal generated by the input device 250. The display device 230 is electrically connected to the second transmission unit 220 to receive and display the video/audio signal and further amplify the screen of handheld electronic device 20 for displaying. The connection unit 240 is provided at a side of the display device 230 and connected to the base 210 for rotating and opening the display device 230, as a book, relative to the base 210 by means of the connection unit 240, in which the opening angle may be adjusted and the display device 230 may be rotated and closed relative to the base 210 by means of the connection unit 240, as shown in FIG. 4.

In the embodiment, the connection unit 240 comprises a hinge to hinge the display 230 to the base 210 and thus rotate and open the display device 230, as a book, relative to the base 210 by means of the connection unit 240, in which the opening angle may be adjusted, which helps the user to adjust the display 230 at an inclination angle for a line-of-sight coverage and ergonomics.

In the embodiment, the clamping unit 270 comprises two clamping portions 274. The clamping portions 274 are opposite to each other and connected to the adjustment portion 272 to adjust the clamping portions 274 for keeping them close to and clamping the handheld electronic device 20. The adjustment portion 272 may comprise a rack or gear (not shown) that is provided on the base 210, and racks that are opposite to each other and provided on the clamping portions 274. With the racks moving relative to each other or the gear and rack moving relative to each other, each of the clamping portions 274 may move in a linear direction and then the portions 274 may keep close to or far from each other for meeting a size of handheld electronic device 20. The clamping unit 270 may further comprise a fixing or locking member to secure the clamping portion 274 that is well adjusted for tightly clamping the handheld electronic device 20. Besides, al long as the clamping portions 274 may keep close to or far from each other, an interval between them may be adjusted for the size of handheld electronic device 20. Thus, one of the clamping portions 274 may be a fixed clamping arm and the other one may be a movable clamping arm that is provided with an adjustment portion and may keep close to or far from the fixed clamping arm, which is not limited to the structure shown in the embodiment and figure. Further, the amount of clamping portions 274 is not limited to that specified in the embodiment of the figure. There may be 4 clamping portions 274; two portions are in pair and thus the two pairs of portions are opposite to each other in the form of tetragon and thus may keep close to each other to clamp the four sides of handheld electronic device 20.

In the embodiment, the input device 250 is, for example, a physical keyboard but not limited to such a manner. The input device 250 may also be a virtual keyboard, a handwriting board, or a touch panel as an input interface.

Thus, with the integrated expansion device according to this invention, the handheld electronic device may be loaded in the receiving region and clamped by the clamping unit. As shown in FIG. 9, the first transmission unit is electrically connected to the second transmission unit. The handheld electronic device then transmits the video/audio signal to the second transmission unit from the first transmission unit, and thus the signal is transmitted to the display device from the second transmission unit, thereby a display screen of operation on the handheld electronic device being shown. When the user uses the input device of integrated expansion device for input operation, the input device generates the first control signal that is transmitted to the second transmission unit. The first control signal is transmitted to the first transmission unit from the second transmission unit and is then processed by the handheld electronic device. Further, the handheld electronic device may be used as a touch panel, and according to the user's operation for control, the handheld electronic device may function as a computation processing center and may thus be formed with a large display, a keyboard, and a touch panel as the input interfaces of the Notebook PC.

In the integrated expansion device 200 in the first embodiment of this invention, the video/audio signal is transmitted between the first transmission unit 22 and the second transmission unit 220 in the manner of wired transmission. As shown in FIG. 3, in the embodiment, the first transmission unit 22 may comprise a HDMI port for transmission and a USB port for transmission that are used to transmit the video/audio signal or another signal; the second transmission unit 220 may correspondingly comprise a HDMI connector for transmission and a USB connector for transmission, and a connection is established by means of a transmission cable to implement signal transmission. The wired transmission interface is not limited to the HDMI interface or the USB interface and may comprise, for example, IEEE 1394, VGA (Video Graphics Array), DVI (Digital Visual Interface), DisplayPort and the like.

Further, the means of transmission between the first transmission unit 22 and the second transmission unit 220 is not limited to the wired transmission, and a means of wireless transmission may also be available; for example, the integrated expansion device 200 and the handheld electronic device 20 may be provided with Bluetooth or NFC (Near Field Communication) as a wireless transmission interface. With a wireless transmission interface chip that is provided in the base 210 of integrated expansion device 200 or on a PCB in the display device 230, the video/audio signal or another signal outputted by the handheld electronic device 20 may be received without connection of any transmission cable and transmission connector.

Next, the integrated expansion device 200 according to this invention may comprise a data read/write device 280 that is electrically connected to the second transmission unit 220 to transmit a read data signal to the first transmission unit 22 from the second transmission unit 220. The data read/write device 280 may be, for example, an optical disk drive, a card reader, or an expansion card slot.

Refer to FIG. 5 as a schematic view illustrating the integrated expansion device in a second embodiment of this invention. In the integrated expansion device 300 in a second embodiment of this invention, the receiving region may be formed with a receiving slot 362. The clamping unit 370 is provided in the receiving slot 362. In the embodiment, the clamping unit 370 comprises an adjustment portion 372 and at least two clamping portions 374. As shown in the figure as an example, the amount of the clamping portions 374 is the amount of those that may be connected in parallel to the adjustment portion 372. The adjustment portion 372 is a member combining the rack with the gear for moving and adjusting the clamping portions 374 so that the clamping portions 374 and the sidewall of receiving slot 362 may clamp and secure together the two opposite sides of handheld electronic device 20. Further, the configuration of clamping portions 374 is not limited to such a manner and the amount of clamping portions may also be 2 by 2 pairs and arranged perpendicularly. As shown in FIG. 6, the two clamping portions and the two sidewalls of receiving slot that are adjacent to each other may be used to clamp the four sides of handheld electronic device 20. In the second embodiment, the base 310, the second transmission unit 320, the display device 330, the connection unit 340, the input device 350, and the data read/write device 380 are the same as or equivalent to the base 210, the second transmission unit 220, the display device 230, the connection unit 240, the input device 250, and the data read/write device 280 in the first embodiment and thus repeated description is not made herein.

Refer to FIGS. 7 and 8 as schematic views illustrating the integrated expansion device in a third embodiment of this invention. In the integrated expansion device 400 in the third embodiment of this invention, the connection unit 440 and the base 410 are respectively provided with opposite gliding parts 444 and opposite guidance grooves 412 for making the display device 430 glide on and connect to the base 410. As shown in the figure as an example, two ends of the connection unit 440 may be formed with the gliding parts 444. The two sides of base 410 may be opposite and provided respectively with the guidance grooves 412 so that the display device 430 may glide relative to the base 410 through the gliding part 444 and the guidance groove 412. When the display device 430 glides and then stays open, the connection unit 440 glides to the other side from the base 410. When the input device 450 and receiving region 460 on the base 410 are completely exposed, the display device 450 may be rotated, opened, and shut relative to the base 410 by means of the connection unit 440, and the display device 430 may face the user at an inclination angle and then stay open as a book or a Notebook PC. When it is not used, the display device 430 may be made to glide and folded on the base 410, staying close as shown in FIG. 8.

On the other hand, as shown in FIG. 10, in the integrated expansion device in the first embodiment through the third embodiment, the display device may be the touch display on which a user touches to generate the second control signal. The second control signal is transmitted to the handheld electronic device from the second transmission unit and the first transmission unit and is then processed by the handheld electronic device. Thus, the user may use the display device for touch operation, thereby the effects of large touch display screen and dual-touch interface being achieved.

Thus, with the integrated expansion device described in the embodiment, the handheld electronic device may be loaded therein to serve as the computation processing center. Further, the handheld electronic device may be used as a touch panel and then work with the display device and input device in the integrated expansion device, and thus when being used, it may have the large display screen and the input interface, thereby implementing a hardware system equivalent to a notebook computer and enhancing applicability and ease of use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An integrated expansion device, being used to load a handheld electronic device provided with a first transmission unit to at least transmit a video/audio signal, the integrated expansion device comprising:
a base, being provided with a receiving region for receiving the handheld electronic device;
a clamping unit, being provided in the receiving region and having at least one adjustment portion that is used to adjust the clamping unit for clamping the handheld electronic device;
an input device, being provided on the base and is adjacent to the receiving region to generate at least one first control signal according to a user's input operation;
a second transmission unit, being electrically connected to the first transmission unit and the input device for at least receiving the video/audio signal from the handheld electronic device and transmitting the first control signal generated by the input device;
a display device, being electrically connected to the second transmission unit for receiving and displaying the video/audio signal; and
a connection unit, being provided at a side of the display device and connected to the base for rotating, opening, and shutting the display device relative to the base.

2. The integrated expansion device according to claim 1, wherein the display device is a touch display on which a user touches to generate a second control signal and the second control signal is transmitted to the handheld electronic device from the second transmission unit and the first transmission unit.

3. The integrated expansion device according to claim 1, wherein the connection unit comprises a hinge for hinging the display device onto the base.

4. The integrated expansion device according to claim 1, wherein the connection unit and the base are respectively provided with a guidance groove and a gliding part that are opposite to each other for making the display device glide on and connect to the base.

5. The integrated expansion device according to claim 1, wherein the clamping unit comprising a plurality of clamping portions and the clamping portions are connected to the adjustment portion to adjust the clamping portions for keeping them close to and clamping the handheld electronic device.

6. The integrated expansion device according to claim 1, wherein the receiving region is further formed with a receiving slot and the clamping unit is provided in the receiving slot.

7. The integrated expansion device according to claim 1, wherein the base further comprises a data read/write device that is electrically connected to the second transmission unit.

8. The integrated expansion device according to claim 1, wherein a wired transmission or a wireless transmission is provided between the first transmission unit and the second transmission unit.

9. The integrated expansion device according to claim 1, wherein the input device is one of a physical keyboard and a virtual keyboard.

10. The integrated expansion device according to claim 1, wherein the handheld electronic device is provided with a touch screen.

11. The integrated expansion device according to claim 1, wherein the handheld electronic device is a Smartphone.
